(19) United States
(12) Patent Application Publication
(10) Pub. No.: US 2024/0189917 A1
(43) Pub. Date: Jun. 13, 2024

(54) CUTTING INSERT, CUTTING TOOL, AND METHOD FOR MANUFACTURING MACHINED PRODUCT

(71) Applicant: KYOCERA CORPORATION, Kyoto-shi, Kyoto (JP)

(72) Inventor: Ryosuke IZUTSU, Kyoto (JP)

(21) Appl. No.: 18/556,348

(22) PCT Filed: Apr. 7, 2022
(86) PCT No.: PCT/JP2022/017228

§ 371 Date: Oct. 20, 2023

(30) Foreign Application Priority Data
Apr. 23, 2021 (JP) 2021-073605

(51) Int. Cl. B23B 27/06

(52) U.S. Cl. CPC B23B 27/06; B23B 2200/08

(57) ABSTRACT

To perform machining on a workpiece under wider variety of machining conditions. A first rising surface is adjacent to a cutting portion across a first surface, the first rising surface being inclined upward away from the first surface in a direction along a center axis and being away from the center axis toward a rear end of a main body. A second rising surface extends from a second surface toward the rear end of the main body, and is inclined upward away from the second surface in the direction along the center axis. In the direction along the center axis, a rear end of the first rising surface is closer to the rear end of the main body than a front end of the second rising surface.

### CROSS-REFERENCE TO RELATED APPLICATIONS

This application is national stage application of International Application No. PCT/JP2022/017228, filed on Apr. 7, 2022, which claims priority to Japanese Patent Application No. 2021-073605, filed on Apr. 23, 2021.

### TECHNICAL FIELD

The present disclosure relates to a cutting insert used in machining for a workpiece, a cutting tool, and a method for manufacturing a machined product.

### BACKGROUND OF INVENTION

As a cutting insert used when machining a workpiece made of a metal material or the like, a cutting insert disclosed in Patent Document 1 has been known, for example. The cutting insert described in Patent Document 1 has a cutting head (cutting portion) and an insert shank (main body). The cutting head has a rake face, a flank face, and a cutting edge. A rising surface is located rearward of the rake face, and the rising surface is inclined upward farther away from the rake face, in a direction along the center axis of the insert shank.

### CITATION LIST

### Patent Literature

Patent Document 1: JP 2013-519537 A

### SUMMARY

A cutting insert according to the present disclosure includes a rod-shaped main body having a rod shape and extending along a center axis from a front end toward a rear end, and a cutting portion protruding laterally from the main body at a side of the front end. The cutting portion includes: a rake face having a triangular shape in top view, and including a corner portion most laterally protruding from the main body at the side of the front end; a first side portion extending from the corner portion toward the main body; and a second side portion extending from the corner portion toward the main body while being located closer to the rear end of the main body than the first side portion. The cutting portion also includes a cutting edge located at least over the corner portion and the first side portion. The main body includes: a first surface continuous with the rake face; a first rising surface adjacent to the cutting portion across the first surface, the first rising surface being inclined upward being away from the first surface in a direction along the center axis and away from the center axis toward the rear end of the main body, a second surface that is adjacent to the first surface across the first rising surface and extends from the front end toward the rear end of the main body; and a second rising surface that extends from the second surface toward the rear end of the main body, and is inclined upward farther away from the second surface, in the direction along the center axis. In the direction along the center axis, a rear end of the first rising surface is closer to the rear end of the main body than a front end of the second rising surface.

### BRIEF DESCRIPTION OF THE DRAWINGS

FIG. 1 is a schematic perspective view of a cutting insert according to an embodiment.

FIG. 2 is a schematic perspective view of the cutting insert illustrated in FIG. 1 as viewed in a direction different from FIG. 1.

FIG. 3 is a schematic plan view of the cutting insert illustrated in FIG. 1.

FIG. 4 is schematic side view of the cutting insert illustrated in FIG. 1.

FIG. 5 is an enlarged view of a part V in FIG. 3.

FIG. 6 is an enlarged view of a part VI in FIG. 4.

FIG. 7 is a cross-sectional view taken along line VII-VII in FIG. 5.

FIG. 8 is a cross-sectional view taken along line VIII-VIII in FIG. 5.

FIG. 9 is a cross-sectional view taken along line IX-IX in FIG. 5.

FIG. 10 is a schematic perspective view of a cutting tool according to an embodiment.

FIG. 11 is a schematic exploded perspective view of the cutting tool illustrated in FIG. 10.

FIG. 12 is a schematic view illustrating a method for manufacturing a machined product according to an embodiment.

FIG. 13 is a schematic view illustrating a method for manufacturing a machined product according to an embodiment.

FIG. 14 is a schematic view illustrating a method for manufacturing a machined product according to an embodiment.

FIG. 15 is a schematic view illustrating a method for manufacturing a machined product according to an embodiment.

### DESCRIPTION OF EMBODIMENTS

A cutting insert, a cutting tool, and a method for manufacturing a machined product according to an embodiment of the present disclosure will be described below in detail with reference to the drawings. However, each of the figures, which will be referred to below, is a simplified representation of only components necessary for description of the embodiments. Accordingly, the cutting insert according to an embodiment of the present disclosure may be provided with an optional component that is not illustrated in the referenced figures. The dimensions of the components in the drawings do not faithfully represent the actual dimensions of the components, the dimension ratios of the members, or the like.

In the present disclosure, the term “center axis” is an axis along the longitudinal direction of the main body, and is an axis passing through the center of at least one of the side of the front end or a side of the rear end of the main body. For example, an axis passing through the center of gravity of the main body when viewed from the side of the rear end and extending along the longitudinal direction may be regarded as the center axis. The term “lateral” refers to a direction orthogonal to a vertical cross-section along the center axis of the main body. The term “flat” refers to a surface that is not a curved surface at a visible level or has no unevenness at a visible level. The “upward-downward direction” is defined with reference to a state in which the rake face of the cutting portion faces vertically upward.

### Cutting Insert

### Overall Configuration of Cutting Insert

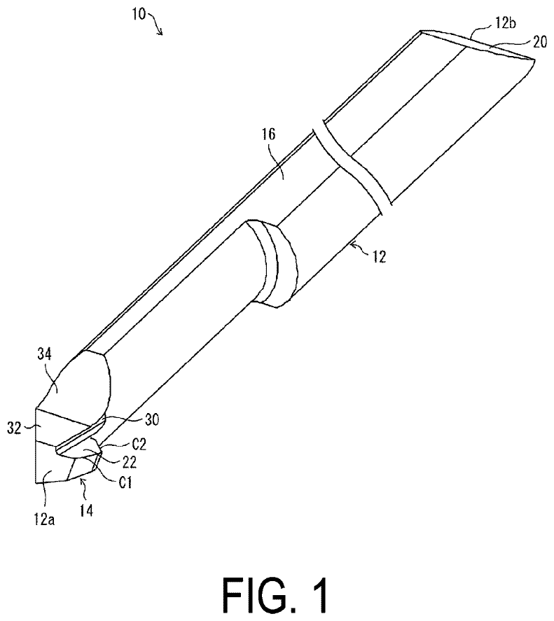

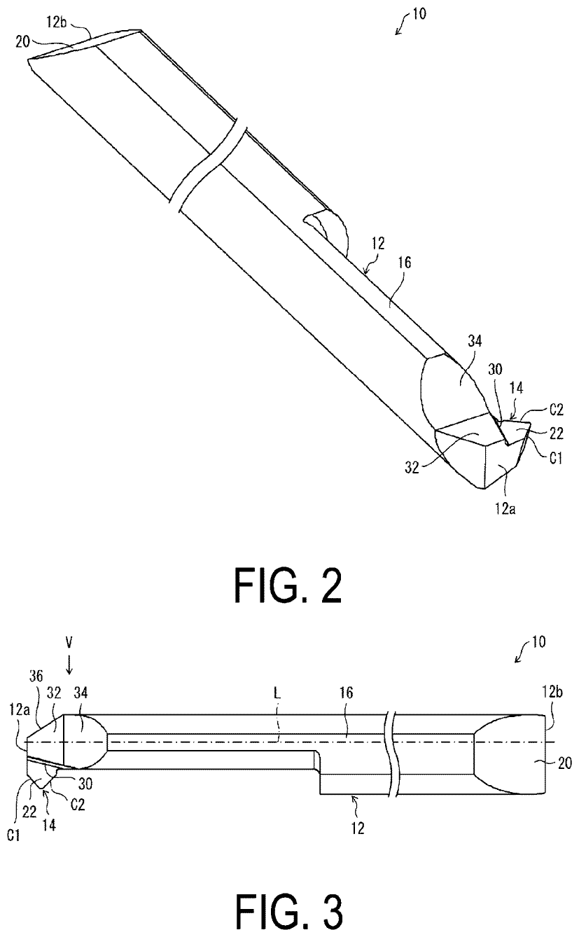

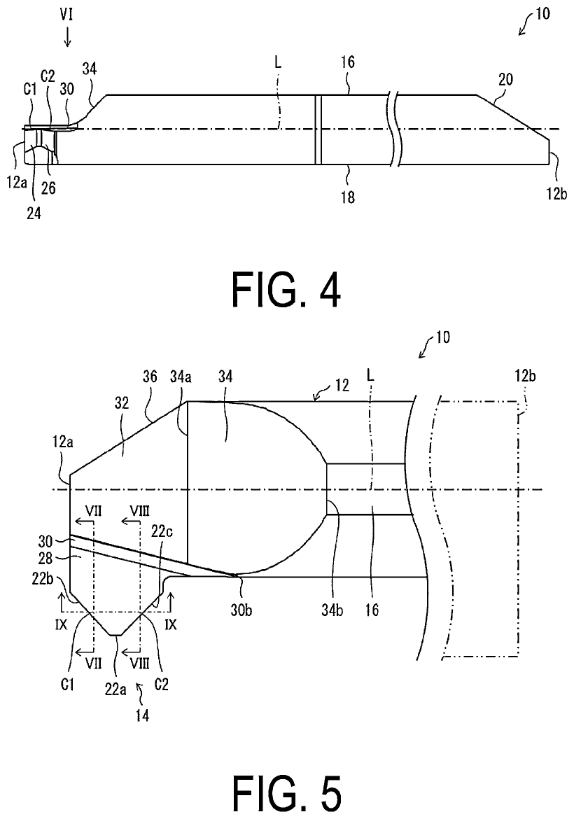

An overall configuration of a cutting insert 10 according to an embodiment of the present disclosure will be described with reference to FIGS. 1 to 4. FIG. 1 is a schematic perspective view of the cutting insert according to the embodiment. FIG. 2 is a schematic perspective view of the cutting insert illustrated in FIG. 1 as viewed in a direction different from that of FIG. 1. FIG. 3 is a schematic plan view of the cutting insert illustrated in FIG. 1. FIG. 4 is schematic side view of the cutting insert illustrated in FIG. 1.

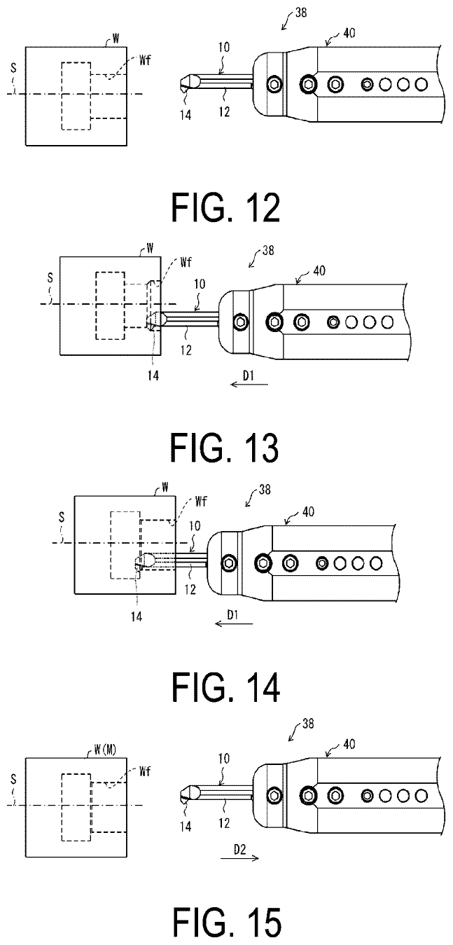

As illustrated in FIGS. 1 to 4, the cutting insert 10 according to the embodiment of the present disclosure is a tool component used for machining of a workpiece W (see FIG. 12) made of a metal material or the like. The cutting insert 10 is mainly used for bore cutting (bore machining), which is one type of machining for the workpiece W. The cutting insert 10 is made of a hard material such as a cemented carbide alloy, a cermet, or a cubic boron nitride (cBN) for example. The cutting insert 10 includes a rod-shaped main body 12 that extends along a center axis L from a front end 12a toward a rear end 12b. The cutting insert 10 includes a cutting portion 14 that comes into contact with the workpiece W to perform machining on the workpiece W. The cutting portion 14 protrudes laterally from the front end 12a side of the main body 12. While the main body 12 and the cutting portion 14 are formed by the same member, the main body 12 and the cutting portion 14 may be formed by different members and may be joined together by joining means such as brazing, for example. In this case, at least the cutting portion 14 is made of a hard material such as cemented carbide alloy, cermet, or cBN, for example.

A flat top surface 16 is located upward of the main body 12, and extends in a direction along the center axis L. A flat bottom surface 18 is located downward of the main body 12, and extends in a direction along the center axis L. An inclined surface 20 is located on the rear end 12b side of the main body 12, and the inclined surface 20 is inclined downward toward the rear end 12b of the main body 12 in a direction along the center axis L.

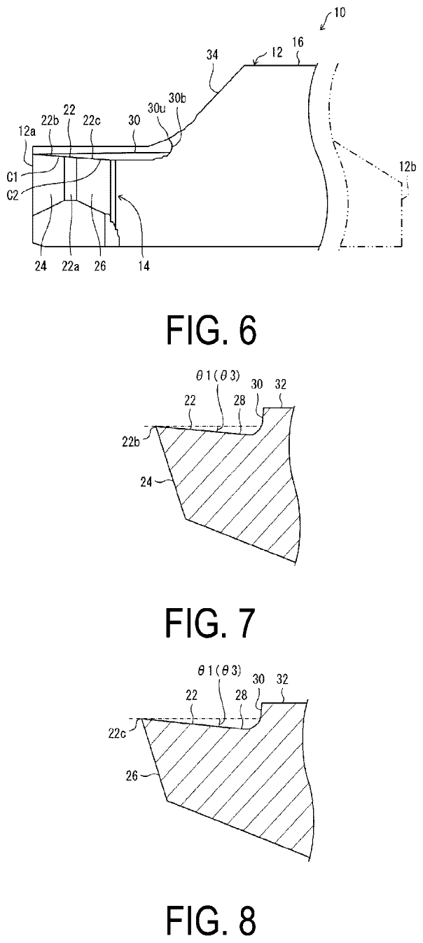

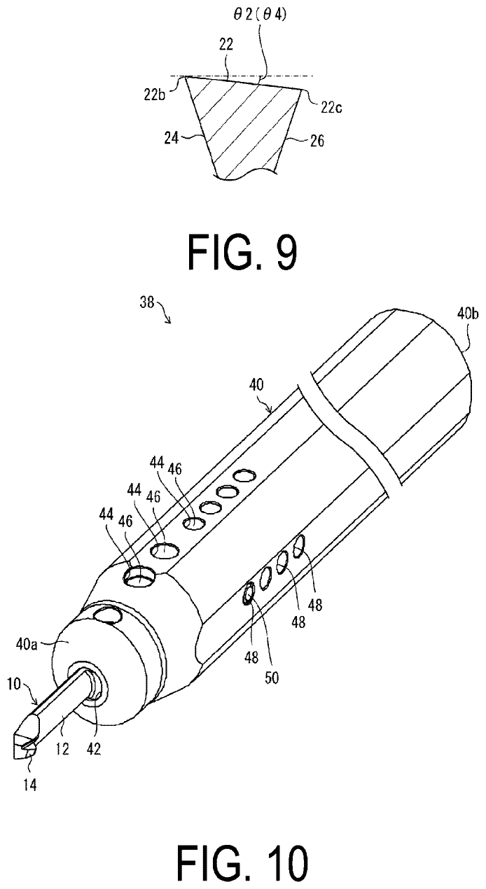

Specific Configuration of Cutting Portion A specific configuration of the cutting portion 14 will be described with reference to FIGS. 5 to 9. FIG. 5 is an enlarged view of a part IV in FIG. 3. FIG. 6 is an enlarged view of a part VI in FIG. 4. FIG. 7 is a cross-sectional view taken along line VII-VII in FIG. 5. FIG. 8 is a cross-sectional view taken along line VIII-VIII in FIG. 5. FIG. 9 is a cross-sectional view taken along line IX-IX in FIG. 5.

As illustrated in FIGS. 5 and 6, the cutting portion 14 has a rake face 22, and the rake face 22 has a triangular shape in top view. The rake face 22 includes a corner portion 22a, which is a portion most laterally protruding from the front end 12a side of the main body 12, and a first side portion 22b extending from the corner portion 22a toward the main body 12. The rake face 22 includes a second side portion 22c extending from the corner portion 22a toward the main body 12, and the second side portion 22c is located closer to the rear end 12b of the main body 12 than the first side portion 22b. The rake face may be, for example, a concave curved surface or a flat surface as illustrated in FIGS. 5 and 6.

The cutting portion 14 has a first cutting edge C1, and the first cutting edge C1 is located over the entire region from the corner portion 22a to the first side portion 22b. The cutting portion 14 has a second cutting edge C2, and the second cutting edge C2 is located over the entire region from the corner portion 22a to the second side portion 22c. A planer first flank face 24 is located below the first cutting edge C1, and a planer second flank face 26 is located below the second cutting edge C2. A first cutting edge C1 is located at an intersection ridge between the rake face 22 and the first flank face 24, and the second cutting edge C2 is located at an intersection ridge between the rake face 22 and the second flank face 26.

As long as the first cutting edge C1 is located over a partial region from the corner portion 22a to the first side portion 22b, the first cutting edge C1 may not be located over the entire region of the first side portion 22b. As long as the second cutting edge C2 is located over a partial region from the corner portion 22a to the second side portion 22c, the second cutting edge C2 may not be located over the entire region of the second side portion 22c. The first cutting edge C1 may be formed with the second cutting edge C2 omitted from the cutting portion 14.

As illustrated in FIGS. 7 to 9, the rake face 22 may be inclined at a first rake angle θ1 downward farther away from the corner portion located more on the downward side, in a direction orthogonal to the center axis L. The rake face 22 may be inclined downward at a second rake angle θ2 closer to the rear end 12b of the main body 12, in a direction along the center axis. With such a configuration, guiding of chips toward a first rising surface 30 described below is facilitated, whereby flow of the chips is easily controlled. In particular, the first rake angle θ1 may be set to be larger than the second rake angle θ2. With such a configuration, flow of the chips toward the rear end 12b of the main body 12 is facilitated, whereby the chip dischargeability is improved.

### Specific Configuration of Main Body 12

A specific configuration of the main body 12 will be described with reference to FIGS. 5 and 6.

As illustrated in FIGS. 5 and 7 to 9, the main body 12 has a first surface 28 continuous with the rake face 22, and the first surface 28 has the same and/or similar function as the rake face 22. The first surface 28 may be, for example, a concave curved surface or a flat surface as illustrated in FIGS. 5 and 7 to 9. Note that the first surface 28 is continuous with the rake face 22 means that the first surface 28 is connected to the rake face 22, for example, with no level difference therebetween. Here, a ridge line may not be formed at the boundary between the first surface 28 and the rake face 22, and these surfaces may be smoothly connected to each other. In this case, chips can smoothly flow from the rake face 22 to the first surface 28.

The first surface 28 may be inclined at a third rake angle θ3 downward farther away from the rake face 22 in a direction orthogonal to the center axis L. The first surface 28 may be inclined at a fourth rake angle θ4 downward toward the rear end 12b of the main body 12 in a direction along the center axis L. With such a configuration, guiding of chips toward a first rising surface 30 described below is facilitated, whereby flow of the chips is easily controlled.

In particular, the third rake angle θ3 may be set to be larger than the fourth rake angle θ4. The third rake angle θ3 and the first rake angle θ1 are set to be the same in the present embodiment for example, but may be set to be different from each other. The fourth rake angle θ4 and the second rake angle θ2 are set to be the same, but may be set to be different from each other. With such a configuration, flow of the chips toward the rear end 12b of the main body 12 is facilitated, whereby the chip dischargeability is improved.

As illustrated in FIGS. 5 and 6, the main body 12 has a first rising surface 30 provided adjacent to the cutting portion 14 across the first surface 28. The first rising surface 30 is inclined in a curved form upward away from the first surface 28, in the direction along the center axis L. The first rising surface 30 has a shape away from the center axis L toward the rear end 12b of the main body 12. The first rising surface 30 has a function as a chip breaker for dividing chips into pieces. When the first rising surface 30 is away from the rake face 22, the area of the rake face 22 is sufficiently secured.

The main body 12 has a flat second surface 32 provided adjacent to the first surface across the first rising surface 30. The second surface 32 extends from the front end 12a toward the rear end 12b of the main body 12. The main body 12 further includes a second rising surface 34 extending from the second surface 32 toward the rear end 12b of the main body 12. The second rising surface 34 is inclined in a curved form upward away from the second surface 32, in the direction along the center axis L. In other words, the second rising surface 34 is raised farther away from the second surface 32. The second rising surface 34 functions as a chip breaker for dividing chips in pieces.

In the direction along the center axis, a rear end 30b of the first rising surface 30 may be closer to the rear end 12b of the main body 12 than a front end 34a of the second rising surface 34, in the direction along the center axis L. In this case, flow control for the chips is facilitated on at least one of the first rising surface 30 or the second rising surface 34. In the direction along the center axis L, a rear end 34b of the second rising surface 34 may be closer to the rear end 12b of the main body 12 than a rear end 30b of the first rising surface 30. In this case, the area of the second rising surface 34 is likely to be secured. Thus, when the cutting depth is large and the feed rate is large, the chips can be stably processed by the second rising surface 34.

In the direction along the center axis, the rear end 34b of the second rising surface 34 may be closer to the rear end 12b of the main body 12 than an upper end 30u of the first rising surface 30, in the direction along the center axis L. In such a case, flow of the chips toward the cutting portion 14 side on the side surface of the main body 12 can be suppressed, and the deterioration of the machined surface accuracy of the workpiece W can be suppressed.

The main body 12 includes a notch 36, and the notch 36 is positioned on the side opposite to the cutting portion 14 on the front end 12a side of the main body 12. The width of the notch 36 may be set to be larger than the width of the cutting portion 14 in the direction along the center axis L. In such a case, the chip dischargeability on the side opposite to the cutting portion 14 in the main body 12 can be improved to suppress chip clogging.

As described above, the first rising surface 30 is provided adjacent to the cutting portion 14 across the first surface 28. Thus, when the cutting depth is small, a process such as dividing of the chips in pieces, for example, can be performed by controlling the flow of the chips by the first rising surface 30.

A described above, the first rising surface 30 has a shape away from the center axis L toward the rear end 12b of the main body 12. The rear end 30b of the first rising surface 30 is closer to the rear end 12b of the main body 12 than the front end 34a of the second rising surface 34 is. Thus, when the cutting depth is large and the feed rate is small, a process for the chips can be performed by controlling the flow of the chips by the first rising surface 30.

As described above, the rear end 30b of the first rising surface 30 is closer to the rear end 12b of the main body 12 than the front end 34a of the second rising surface 34. The rear end 34b of the second rising surface 34 is closer to the rear end 12b of the main body 12 than the rear end 30b of the first rising surface 30. As a result, the first rising surface 30 and the second rising surface 34 overlap each other in the direction along the center axis L, and the chips can be kept from flowing without coming into contact with both of the first rising surface 30 and the second rising surface 34. Thus, when the cutting depth is large and the feed rate is large, the chips can be processed by the second rising surface 34. Also when the cutting depth is large and the feed rate is moderate, chips can be processed by at least one of the first rising surface 30 or the second rising surface 34.

Thus, according to the embodiment of the present disclosure, machining of the workpiece W can be performed under a wide variety of machining conditions.

### Cutting Tool

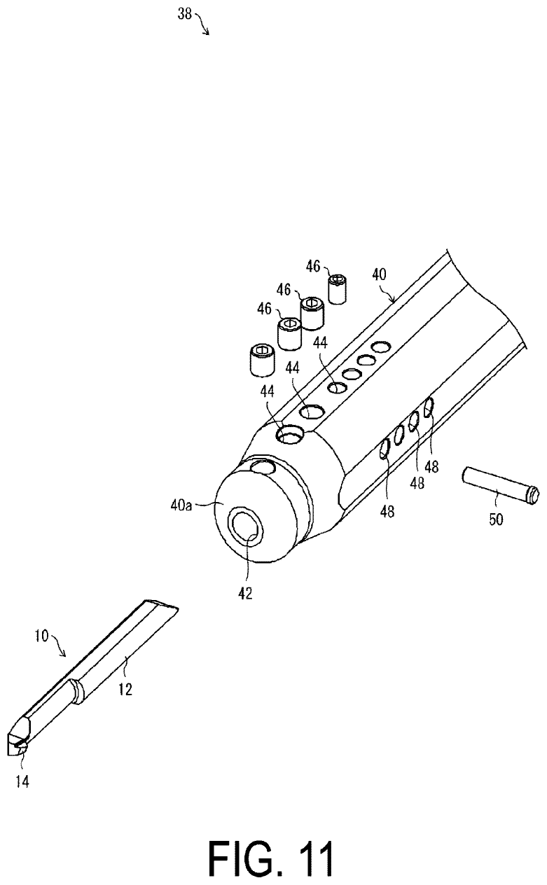

The cutting tool according to the embodiment of the present disclosure will be described with reference to FIGS. 10 and 11. FIG. 10 is a schematic perspective view of the cutting tool according to the embodiment. FIG. 11 is a schematic exploded perspective view of the cutting tool illustrated in FIG. 10.

As illustrated in FIGS. 10 and 11, a cutting tool 38 according to the embodiment includes a rod-shaped holder 40, and the holder 40 extends from a front end 40a toward a rear end 40b thereof. The holder 40 is made of a metal material such as steel. The holder 40 has a hole-shaped pocket 42, and the pocket 42 is located at the front end 40a of the holder 40. The cutting tool 38 includes the cutting insert 10 located in the pocket 42, and the main body 12 is removably mounted in the pocket 42.

The holder 40 includes a plurality of screw holes 44, and the plurality of screw holes 44 are located at an upper portion of the holder 40. Bolts 46 are screwed and positioned in the plurality of screw holes, and press the top surface 16 (see FIGS. 3 and 4) of the main body 12. The holder 40 includes plurality of pin holes 48, and the plurality of pin holes 48 are located at a side portion of the holder 40. A pin 50 is positioned in any of the plurality of pin holes 48, and the pin 50 is in contact with the inclined surface 20 (see FIGS. 3 and 4) of the main body 12. As a result, the cutting insert 10 can be fixed to the holder 40, in a state in which the protruding length of the cutting insert 10 with respect to the holder 40 is adjusted.

### Method for Manufacturing Machined Product

Next, a description will be given of a method for manufacturing a machined product according to an embodiment of the present disclosure with reference to FIGS. 11 to 14. FIGS. 12 to 15 are schematic views illustrating a method for manufacturing the machined product according to the embodiment.

As illustrated in FIGS. 12 to 15, the method for manufacturing a machined product according to the embodiment is a method for manufacturing a machined product M which is a workpiece W after the machining, and includes a first step, a second step, and a third step. The first step is a step of rotating the workpiece W about its axis S. The second step is a step of bringing the cutting insert 10 of the cutting tool 38 into contact with the rotating workpiece W. The third step is a step of separating the cutting tool 38 from the workpiece W. The specific content of the method for manufacturing the machined product according to the embodiment is as follows.

As illustrated in FIG. 12, the workpiece W is mounted on a chuck (not illustrated) of a lathe, and the chuck is rotated to rotate the workpiece W about its axis S. As illustrated in FIG. 13, the cutting tool 38 is moved in the direction of an arrow D1 to approach the workpiece W, and the cutting portion 14 of the cutting insert 10 is brought into contact with an inner circumferential surface Wf of the machined hole of the rotating workpiece W. As illustrated in FIG. 14, the cutting tool 38 is moved along the axis S of the workpiece W while the cutting portion 14 of the cutting insert 10 is brought in contact with the inner circumferential surface Wf of the machined hole of the workpiece W. As a result, machining of the workpiece W is performed, and the inner circumferential surface Wf of the machined hole of the workpiece W can be finished as a machined surface.

Then, as illustrated in FIG. 15, the cutting tool 38 is moved away from the workpiece W by moving the cutting tool 38 in the direction of an arrow D2. As a result, the cutting of the workpiece W is completed, and a machined product M, which is the workpiece W after the machining, can be manufactured. The cutting insert 10 has excellent cutting capabilities because of the above reasons, making it possible to manufacture the machined product M excellent in machining accuracy.

When the machining is continued, the step of bringing the cutting portion 14 of the cutting insert 10 into contact with a different portion of the workpiece W may be repeated, while the workpiece W is rotated. Although the cutting tool 38 is brought close to the workpiece W in the present embodiment, the cutting tool 38 only needs to be brought relatively close to the workpiece W. Thus, for example, the workpiece W may be brought close to the cutting tool 38. The same applies to the case where the cutting tool 38 is separated from the workpiece W.

In the present disclosure, the invention has been described above based on the various drawings and examples. However, the invention according to the present disclosure is not limited to each embodiment described above. That is, the embodiments of the invention according to the present disclosure can be modified in various ways within the scope illustrated in the present disclosure, and embodiments obtained by appropriately combining the technical means disclosed in different embodiments are also included in the technical scope of the invention according to the present disclosure. In other words, a person skilled in the art can easily make various variations or modifications based on the present disclosure. Note that these variations or modifications are included within the scope of the present disclosure.

1. A cutting insert comprising:
a main body extending along a center axis from a front end toward a rear end; and
a cutting portion protruding laterally from the main body at a side of the front end, wherein
the cutting portion comprises:
a rake face having a triangular shape in top view, and comprising a corner portion most laterally protruding from the main body, a first side portion extending from the corner portion toward the main body, and a second side portion extending from the corner portion toward the main body and being located closer to the rear end of the main body than the first side portion; and
a cutting edge located at the corner portion and the first side portion, the main body comprises:
a first surface continuous with the rake face;
a first rising surface adjacent to the cutting portion across the first surface, the first rising surface being inclined upward away from the first surface in a direction along the center axis and being away from the center axis toward the rear end of the main body,
a second surface adjacent to the first surface across the first rising surface and extending from the front end toward the rear end of the main body; and
a second rising surface extending from the second surface toward the rear end of the main body and being inclined upward away from the second surface in the direction along the center axis, and
in the direction along the center axis, a rear end of the first rising surface is closer to the rear end of the main body than a front end of the second rising surface.

2. The cutting insert according to claim 1, wherein in the direction along the center axis, a rear end of the second rising surface is closer to the rear end of the main body than the rear end of the first rising surface.

3. The cutting insert according to claim 1, wherein the first rising surface is separated from the rake face.

4. The cutting insert according to claim 1, wherein the rake face is inclined at a first rake angle downward farther from the corner portion in a direction orthogonal to the center axis, and is inclined at a second rake angle downward toward the rear end of the main body in the direction along the center axis.

5. The cutting insert according to claim 4, wherein the first rake angle is larger than the second rake angle.

6. The cutting insert according to claim 4, wherein the first surface is inclined at a third rake angle downward farther from the rake face in a direction orthogonal to the center axis, and is inclined at a fourth rake angle downward toward the rear end of the main body in the direction along the center axis.

7. The cutting insert according to claim 1, wherein in the direction along the center axis, the rear end of the first rising surface is closer to the rear end of the main body than an upper end of the first rising surface.

8. The cutting insert according to claim 1, wherein the main body has a notch located on a side opposite to the cutting portion on the side of the front end of the main body, and a width of the notch is larger than a width of the cutting portion in the direction along the center axis.

9. A cutting tool comprising:
a holder having a rod shape extending from a front end toward a rear end, and comprising a pocket positioned at the front end of the holder; and
the cutting insert according to claim 1 positioned in the pocket.

10. A method for manufacturing a machined product, the method comprising:
rotating a workpiece;
bringing the cutting tool according to claim 9 into contact with the workpiece rotating; and
separating the cutting tool from the workpiece.
